(19) United States
(12) Patent Application Publication
(10) Pub. No.: US 2013/0017307 A1
(43) Pub. Date: Jan. 17, 2013

(54) BLACK TEA BEVERAGE PACKED IN A CONTAINER

(71) Applicants: Yu Kanda, Makinohara-shi (JP); Keisuke Numata, Makinohara-shi (JP); Toyo Imbe, Makinohara-shi (JP); Mitsumasa Shida, Shibuya-ku (JP)

(72) Inventors: Yu Kanda, Makinohara-shi (JP); Keisuke Numata, Makinohara-shi (JP); Toyo Imbe, Makinohara-shi (JP); Mitsumasa Shida, Shibuya-ku (JP)

(73) Assignee: ITO EN, LTD.

(21) Appl. No.: 13/521,106

(22) PCT Filed: Dec. 22, 2010
(86) PCT No.: PCT/JP2010/073102

§ 371 Date: Jul. 9, 2012

(30) Foreign Application Priority Data
Jan. 29, 2010 (JP) 2010-019773

(51) Int. Cl. A23F 3/38

(52) U.S. Cl. 426/597

(57) ABSTRACT

Disclosed is a pleasantly mild new acidic black tea beverage in which bitter and astringent flavors are suppressed. The black tea beverage packed in a container contains sweeteners and fruit juice and 0.001 to 0.005 wt % caffeine, and is characterized by having acidity of 0.02 to 0.08%, and, when the acidity is within the aforementioned range, and a sweetness/dryness of 1.50 to 2.50, said sweetness/dryness being expressed using sweetness (total solids content) and acidity.

### TECHNICAL FIELD

The present invention relates to a black tea beverage packed in a container that contains a sweetener and fruit juice.

### BACKGROUND ART

A black tea is a fermented tea, differently from a non-fermented tea such as a green tea, and thus has different components and features from those of a green tea and the like. For example, catechins, which are largely contained in a green tea, go through polymerization by oxidation action from fermentation, whereby to produce theaflavin (orange color pigment, astringent taste) and thearubigin (red pigment). In addition, components called proanthocyanidin polymers form astringent taste and bitter taste, and along with added theanine (sweetness, deliciousness) and caffeine, form unique tastes of a black tea.

A fruit juice-containing black tea beverage in which fruit juice is added to a black tea, has been preferred and drunk from the past due to astringent taste from a black tea and refreshing feeling from fruit juice, as represented by a black tea beverage to which lemon fruit juice is added.

Regarding such fruit juice-containing black tea beverage, the following new suggestions have been made.

For example, a fruit juice-containing black tea beverage has been suggested, which relates to a fruit juice-containing black tea beverage that contains fruit juice such as orange, lemon and apple, and a black tea extract, and which allows experience of the flavor of the fruit juice and the flavor of the black tea at the same time by adjusting the pH thereof to 4.0 to 4.6 (Patent Document 1).

In addition, if a fruit juice-containing black tea beverage is stored for a long time, turbidity or precipitation occurs. Thus, a method of suppressing turbidity or precipitation by treating an extraction liquid of black tea with tannase, is disclosed (Patent Document 2).

### CITATION LIST

### Patent Document

Patent Document 1: JP H07-67533 A

Patent Document 2: JP 2000-37164 A

### DISCLOSURE OF THE INVENTION

### Problem to be Solved by the Invention

As described above, a conventional fruit juice-containing black tea beverage has been preferred and drunk due to astringent taste of a black tea and refreshing feeling from fruit juice or acidic ingredients. However, from recent change of liking, people tend to increase, who strongly sense pungent taste, such as who strongly sense astringent taste, and who sense convergent taste as aftertaste.

Therefore, the present invention provides a new acidic black tea beverage that has bitter astringent taste and convergent taste suppressed, and thus senses soft with low pungent taste.

### Means for Solving Problem

The present invention suggests a black tea beverage packed in a container that contains caffeine in 0.001 to 0.005 mass %, and contains a sweetener and fruit juice, and the black tea beverage has the acid degree in a range of 0.02 to 0.08%, and the degree of sweetness/dryness represented by the sugar degree and the acid degree within the range of 1.50 to 2.50 when the acid degree is within the range.

Such black tea beverage packed in a container has bitter astringent taste and convergent taste suppressed, and senses soft with low pungent taste when drunk.

### Modes for Carrying Out the Invention

Hereinafter, an illustrative embodiment of the present invention will be explained, but the scope of the present invention is not limited to the illustrative embodiment.

<Present Black Tea Beverage>

The black tea beverage packed in a container related to the present illustrative embodiment (hereinafter, referred to as “the present black tea beverage”) is a black tea beverage that contains a sweetener and fruit juice, and the black tea beverage has the acid degree and the degree of sweetness/dryness within the given ranges.

The present black tea beverage is a black tea beverage packed in a container that contains an extraction liquid of black tea (including a black tea concentrate), fruit juice, a sweetener and other additives.

(Extraction of Black Tea)

An extraction liquid of black tea can be obtained by, for example, immersing black tea leaves in a solvent, and stirring, and then removing the black tea leaves by a solid-liquid separation means.

However, a commercially available extraction liquid of black tea (including a black tea concentrate) may be also used.

The black tea leaves for the extraction liquid of black tea may be black tea leaves that are generally used in a black tea beverage, in other words, black tea leaves obtained by fermenting live tea leaves and manufacturing a tea.

A kind of the black tea such as tea season or shape and production area of the black tea is not particularly limited, but in the present black tea beverage, the kind of the black tea is preferably selected particularly for the purpose of adjusting theogallin amount to a desired range. For example, tea leaves having a large leaf tend to have a large content of theogallin. For example, Darjeeling, Nilgiri and the like are tea leaves having a high content of theogallin. Reversely, Uva, Dimbula and the like are tea leaves having a small content of theogallin. Accordingly, on the basis of such viewpoint, theogallin content may be adjusted to a desired content of theogallin by selecting a kind of tea leaves, and mixing multiple kinds of tea leaves as necessary.

Furthermore, in reducing the amount of caffeine of black tea leaves, the amount of caffeine may be reduced by, for example, subjecting tea leaves to supercritical treatment, by washing tea leaves with warm water, or contacting the extraction liquid with a hydrogen ion exchange resin, or contacting the extraction liquid with active white earth or acidic white earth.

Presently, tea leaves of which the amount of caffeine is reduced in advance are also commercially available.

Extraction of black tea leaves may be conducted, for example, by performing extraction at normal pressures in accordance with an ordinary method using an extracting equipment called a kneader with water of 10 to 100° C. in an amount of 5 to 100 folds with respect to a raw tea for about 1 minute to 40 minutes, with stirring once to several times as necessary. Furthermore, the extraction is performed preferably at 10 to 90° C., more preferably 20 to 80° C., and further preferably 30 to 70° C. from a viewpoint of appropriate flavor and preventing fluid color change on the target of the content of theogallin.

However, the extraction method, the extraction conditions and the like are not particularly limited, and for example, pressurization extraction may be also performed.

The warm water used in the extraction liquid may be exemplified by pure water, hard water, soft water, ion exchanged water, natural water, and the like, and in addition, an aqueous solution that contains ascorbic acid and pH preparation water and the like.

To the fluid for extraction, organic acid such as sodium ascorbate or organic acid salts may be also added.

The solid-liquid separation after the extraction may be performed by filtration, centrifugation and the like, and the black tea leaves are removed whereby to obtain an extraction liquid of black tea. For example, a filtration method that is presently adopted in order to remove extraction residues such as a stainless-steel filter, a cotton cloth, and a strainer, may be arbitrarily adopted. In addition, as necessary, further centrifugation or diatomaceous earth filtration may be also performed.

(Ratio of Solid Content Derived from Black Tea with Respect to Total Solid Content)

With respect to the solid content derived from a black tea in the present black tea beverage, the ratio of the solid content derived from a black tea with respect to the total solid content is preferably 2.0 to 8.0%. When the solid content derived from a black tea is 2.0% or more, the richness taste (concentration feeling) is full. When the solid content derived from a black tea is 8.0% or less, the astringent taste and the convergent taste are not strongly sensed.

From such viewpoint, the ratio of the solid content derived from a black tea with respect to the total solid content is preferably 2.0 to 8.0%, particularly 3.0% or more and 7.0% or less, and further particularly preferably 4.0% or more and 5.0% or less.

Furthermore, the solid content derived from a black tea may be adjusted with the addition amount of an extraction liquid of black tea and a black tea concentrate.

(Fruit Juice)

The kind of the fruit juice added to the present black tea beverage is not particularly limited. For example, examples of the kind of the fruit juice include orange, peach, white grape, apple, lemon, strawberry, grapefruit, mango, pear, bergamot and the like, which may be used as one kind or in combination of 2 or more kinds.

Furthermore, the fruit juice is preferably selected in consideration of compatibility of the kind of black tea leaves and the fruit juice, and compatibility of the fruit juices combined to each other.

In addition, from a viewpoint of enhancing the aftertaste and the texture of the fruit juice of the present black tea beverage, the acid degree of the fruit juice added is preferably 3.0% or less, particularly 0.1% or more and 2.0% or less, and further particularly 0.2% or more and 1.0% or less. From such viewpoint, a fruit juice other than lemon, for example, apple, orange, peach or the like is preferable.

(Amount of Fruit Juice)

The amount of the fruit juice in the present black tea beverage (in compliance with Japanese agricultural standards (JAS)) is preferably 0.05 mass % or more and 5.0 mass % or less, and particularly more preferably 0.1 mass % or more and 3.0 mass % or less from a viewpoint of obtaining appropriate feeling of the black tea and feeling of the fruit juice.

(Sweetener)

The present black tea beverage contains a sweetener, and the kind of the sweetener is not particularly limited, which may be any one of sugars or an artificial sweetener. Examples of the sugars include, for example, table sugar, glucose, fructose, sucrose, reduced maltose and the like. Examples of the artificial sweetener include, for example, xylitol, stevia extract, palatinose, aspartame, acesulfame-K, stevia, saccharin, saccharin sodium, sucralose and the like.

From a viewpoint of adjusting the degree of sweetness/dryness and the acid taste to be well-balanced, sugars, which have an influence on the degree of sweetness/dryness sugars, and an artificial sweetener, which has no influence on the degree of sweetness/dryness, are preferably used together from a point of adjusting the flavor.

(Caffeine)

The content of caffeine in the present black tea beverage is importantly 0.001 to 0.005 mass %. When the content of caffeine is 0.001 mass % or more, feeling of drink going down one's throat is good. When the content of caffeine is 0.005 mass % or less, the bitter taste is not strong.

Accordingly, from such viewpoint, the content of caffeine is importantly 0.001 to 0.005 mass %, preferably 0.002 or more and 0.004 or less, and particularly further preferably 0.0025 or more 0.0035 or less. Furthermore, the content of caffeine in the present black tea beverage may be adjusted with using caffeine-reduced tea leaves as described above, adjusting extraction conditions and the like.

(Content of Theogallin)

Theogallin (3-galloylquinic acid) presents taste of the astringent-like taste, and has a large influence on formation of full-scale black tea-like flavor.

The content of theogallin in the present black tea beverage is preferably 0.001 mass % to 0.002 mass %. When the content of theogallin is 0.001 mass % or more, the richness taste (concentration feeling) of the black tea is sensed, and full-scale feeling of the black tea can be obtained. On the other hand, when the content of theogallin is 0.002 mass % or less, it is preferable in a point of having no outstanding feeling of the black tea from too strong astringent taste.

From such viewpoint, the content of theogallin is preferably 0.001 to 0.002 mass %, particularly 0.0012 mass % or more and 0.0018 mass % or less, and further preferably 0.0013 mass % or more and 0.0015 mass % or less.

(Ratio of Caffeine/Theogallin)

From a viewpoint of lessening the pungent taste from the bitter astringent taste and the astringent taste in the present black tea beverage, the ratio of the content of caffeine with respect to the content of theogallin is further preferably adjusted.

In other words, the content of caffeine with respect to the content of theogallin in the present black tea beverage is preferably 1.0 to 4.9. When the content of caffeine with respect to the content of theogallin in the present black tea beverage is 1.0 to 4.9, the pungent taste from the bitter astringent taste and the astringent taste can be reduced.

From such viewpoint, the ratio of the content of caffeine with respect to the content of theogallin in the present black tea beverage, is preferably 1.0 to 4.9, particularly 1.5 or more and 4.5 or less, and further particularly preferably 2.0 or more and 4.0 or less.

(Acid Degree)

The acid degree of the present black tea beverage is importantly 0.02 to 0.08%.

When the acid degree is 0.02% or more, refreshing feeling can be sensed, and when the acid degree is 0.08% or less, the pungent taste from too strong acid taste is not strongly sensed.

From such viewpoint, the acid degree in the present black tea beverage is importantly 0.02 to 0.08%, particularly preferably 0.035 or more and 0.065 or less and further particularly preferably 0.04 or more and 0.055 or less.

Furthermore, the acid degree of the present black tea beverage may be adjusted mainly with the kind and the content of the fruit juice, the kind and the addition amount of acidic ingredients, and the like.

(Degree of Sweetness/Dryness)

The degree of sweetness/dryness is a marker represented by the sugar degree (total solid content) and the acid degree.

The degree of sweetness/dryness in the present black tea beverage when the acid degree is within 0.02 to 0.08%, is importantly within 1.50 to 2.50. When the degree of sweetness/dryness is 1.50 or more, the acid taste is not too strong and the pungent taste is not strong. On the other hand, when the degree of sweetness/dryness is 2.50 or less, the sweet taste is not too strong, and the residual taste is not sensed, from which the degree of sweetness/dryness within 1.50 to 2.50 is preferable.

Accordingly, the degree of sweetness/dryness in the present black tea beverage when the acid degree is within 0.02 to 0.08% is preferably 1.50 to 2.50, particularly more preferably 1.65 or more and 2.35 or less, and further preferably 1.80 or more and 2.20 or less.

Furthermore, the degree of sweetness/dryness of the present black tea beverage may be adjusted with adjusting, for example, the kind and the amount of sugars (table sugar or fructose), the kind and the amount of the fruit juice, the addition amount of a black tea extract, the addition amount of acidic ingredients and the like.

(Tartaric Acid)

Furthermore, from a viewpoint of the aftertaste and refreshing taste, the ratio of the content of tartaric acid with respect to the content of acidic ingredients (tartaric acid/acidic ingredients) in the present black tea beverage is preferably 0.30 to 0.80. When this ratio of tartaric acid/acidic ingredients is 0.30 or more, it is preferable in a point that no sharp acid taste is induced and refreshing and soft acid taste is obtained. When the ratio of tartaric acid/acidic ingredients is 0.80 or less, it is preferable in a point that the astringent taste is not sensed in the aftertaste.

Accordingly, the ratio of tartaric acid/acidic ingredients in the present black tea beverage is preferably 0.30 to 0.80, particularly more preferably 0.4 or more and 0.7 or less, and further preferably 0.45 or more and 0.65 or less.

Furthermore, the ratio of the content of tartaric acid/the content of acidic ingredients in the present black tea beverage may be adjusted with, for example, the addition amount of tartaric acid.

(Content of Theaflavins)

The content of theaflavins in the present black tea beverage is preferably 0.0002 mass % to 0.0012 mass %. When the content of theaflavins is 0.0002 mass % or more, it is preferable in a point that temporal color tone change and appropriate feeling of the black tea are obtained. On the other hand, when the content of theaflavins is 0.0012 mass % or less, it is preferable in a point that temporal change is suppressed, and a balance of the black tea and the fruit juice is possessed.

Accordingly, from such viewpoint, the content of theaflavins in the present black tea beverage is preferably 0.0002 mass % to 0.0012 mass %, particularly 0.0004 mass % or more and 0.0008 or less, and further particularly preferably 0.0006 mass % or more and 0.0007 mass % or less.

Furthermore, the content of theaflavins may be adjusted with manufacturing conditions of an extraction liquid of the black tea to be added (kinds of tea leaves, extraction temperature, extraction conditions) and the like.

(Ratio of Theogallin/Theaflavin)

The ratio of the content of theogallin with respect to the content of theaflavin in the present black tea beverage is further preferably adjusted from a viewpoint of appropriate astringent taste and flavor of the black tea, and suppression of temporal color tone change.

In other words, the ratio of the content of theogallin with respect to the content of theaflavin (theogallin/TF) in the present black tea beverage is preferably 1 to 15. When the ratio of theogallin/TF in the present black tea beverage is 1 to 15, it can give appropriate feeling of the black tea and lessen temporal color tone change.

From such viewpoint, the ratio of the content of theogallin with respect to the content of theaflavin (theogallin/TF) in the present black tea beverage is preferably 1 to 15, particularly 1.5 or more and 5 or less and further particularly preferably 1.85 or more and 2.5 or less.

(Content of Catechins)

In addition, the content of catechins in the present black tea beverage is preferably 0.002 mass % to 0.006 mass %. When the content of catechins is 0.002 mass % or more, it is preferable in a point that the richness taste (concentration feeling of the black tea) is sensed. On the other hand, when the content of catechins is 0.006 mass % or less, it is preferable in a point that the astringent taste and the convergent taste are not sensed.

Accordingly, from such viewpoint, the content of catechins in the present black tea beverage is preferably 0.002 mass % to 0.005 mass %, particularly 0.0025 mass % or more and 0.0045 mass % or less and further particularly preferably 0.0030 mass % or more and 0.0040 mass % or less.

Furthermore, the content of catechins may be adjusted with the addition amount of an extraction liquid of black tea and a black tea concentrate.

(Total Solid Content)

The total solid content in the present black tea beverage is preferably 3.2 to 4.6%. When the total solid content is 3.2% or more, it is preferable in a point that the taste does not become watery and thick taste is sensed. On the other hand, when the total solid content is 4.6% or less, it is preferable in a point that good concentration feeling as much is obtained, and the residual taste of the aftertaste is not sensed.

Accordingly, from such viewpoint, the total solid content in the present black tea beverage is preferably 3.2 to 4.6%, particularly 3.5% or more and 4.3% or less and further particularly preferably 3.7% or more and 4.2% or less.

Furthermore, the total solid content of the present black tea beverage may be adjusted with, for example, the amount of sugars (table sugar or fructose), the amount of a black tea extract, the amount of the fruit juice and the addition amount of other additives.

(pH)

The pH in the present black tea beverage is preferably 3.0 to 5.0. When the pH is 3.0 or more, it is preferable in a point that creamdown phenomenon hardly occurs, and the acid taste is not too strong. When the pH is 5.0 or less, it is preferable in a point that appropriate acid taste is obtained without no sense of acid taste.

Accordingly, from such viewpoint, pH in the present black tea beverage is preferably 3.0 to 5.0, particularly 3.5 or more and 4.5 or less and further particularly preferably 3.7 or more and 4.2 or less.

<Manufacturing Method>

The present black tea beverage can be manufactured by mixing and blending an extraction liquid of black tea (including a black tea concentrate), fruit juice, a sweetener, and other additives, and filling the blend into a container and sterilizing it.

(Blending)

Blending may be performed by adding to an extraction liquid of black tea (including a black tea concentrate), fruit juice and other additives, for example, a sweetener, acidic ingredients, tartaric acid and other blends, for example, water (hard water, soft water, ion exchanged water, natural water, and others), ascorbic acid, sodium ascorbate, sodium bicarbonate, sugars, dextrin, a flavoring, an emulsifier, a stabilizer, or other taste raw materials, as alone of any one kind or in combination of two or more kinds thereof, and adjusting mainly pH, the concentrations and the tastes.

In the blending, 2 or more kinds of extraction liquids of black tea (containing a black tea concentrate) that are different in the content of caffeine, the content of theogallin, the content of theaflavins, the content of catechins and the solid content derived from the black tea, may be combined and mixed to adjust the content of caffeine, the content of theogllin, the content of theaflavins, the content of catechins and the solid content derived from a black tea and the like.

(Sterilization and Filling into Container)

Examples of the heat sterilization include a method comprising heating, for example, to 95° C. (hot pack), and then performing filling and over-turn sterilization in the case where the beverage is a can beverage. After the filling, it is of no matter if necessary to perform a method of performing retort sterilization (for example, heat sterilization under suitable pressure (1.2 kg/cm² and the like) at 121° C. for 7 minutes.), or perform UHT sterilization (keeping the blended fluid at 115° C. to 150° C. for 1 second to tens of seconds.) in the case of a plastic bottle beverage.

<Method of Adjusting Flavor of Black Tea Beverage Packed in a Container>

As described above, the flavor of the black tea beverage packed in a container may be adjusted by adjusting caffeine to 0.001 to 0.005 mass %, and adjusting the acid degree to a range of 0.02 to 0.08%, and adjusting the degree of sweetness/dryness represented by the sugar degree (total solid content) and the acid degree to a range of 1.50 to 2.50 when the acid degree is within the range.

<Explanation for Terms>

The “black tea beverage packed in a container” in the present invention means a black tea beverage contained in a container, and also means a black tea beverage that may be drunk without dilution.

In addition, the “catechins” represents catechin (C), gallocatechin (GC), catechin gallate (Cg), gallocatechin gallate (GCg), epicatechin (EC), epigallocatechin (EGC), epicatechin gallate (ECg) and epigallocatechin gallate (EGCg), and the amount thereof means a total amount of them.

In addition, the “theaflavins” represents theaflavin (TF), theaflavin 3-o-gallate (TF3-G), theaflavin 3′-o-gallate (TF3′-G), and theaflavin 3,3′-di-o-gallate (TF3,3′-G), and the amount thereof means a total amount of them.

When “X to Y” (X and Y are any number) is expressed in the present specification, it means “X or more and Y or less” unless otherwise stated.

### EXAMPLES

Hereinafter, the present invention will be further specifically explained with Examples. However, the present invention is not limited to these Examples.

(Amount of Caffeine)

The amount of caffeine was measured with HPLC method in compliance with the method of Goto et al. (T. Goto, Y. yoshida, M. kiso and H. Nagashima, Journal of chromatography A 749 (1996) 295-299).

(Amount of Theogallin)

The black tea beverage packed in a container obtained in Examples and Comparative Examples was filtered with 0.2 μm hydrophilic PTFE filter (Millipore Japan), and then theogallin was quantified using UPLC under the conditions described below.

Equipment: ACQUITY UPLC/PDA System (Waters Japan), Mobile Phase (Fluid A): Aqueous solution of 0.1% phosphoric acid,

Mobile Phase (Fluid B): Acetonitrile,

Gradient: Elution Fluid B 0% (0 minute)→0% (1 minute)→3% (3.5 minutes),

Flow Rate: 0.5 mL/min,

Detection: UV 275 nm,

Sample injection amount: 5 μL,

Column temperature: 40° C.

(Amount of Catechins)

Quantification of catechins was performed in compliance with the method of Goto et al. (T. Goto, Y. Yoshida, M. Kiso and H. nagashima, Journal of Chromatography A, 749 (1996) 295-299).

The black tea beverage packed in a container obtained in Examples and Comparative Examples was added with metaphosphoric acid, and extracted.

The extraction liquid was volume-fixed, and then measured with high-performance liquid chromatography method (HPLC method).

(Amount of Theaflavins)

Quantification of theaflavins was performed in compliance with the method of Andrew P. Nelson et al. (Andrew P. Nelson, Rodney J. Green, Karl V. Wood, Mario G. Ferruzzi, Journal of Chromatography A, 1132 (2006) 132).

The black tea beverage packed in a container obtained in Examples and Comparative Examples was diluted with 50% acetonitrile, volume-fixed, and then measured with high-performance liquid chromatography method (HPLC method).

(Solid Content Derived from a Black Tea)

Tea leaves only were extracted and filtered (before addition of fruit juice, sugars, and acidic ingredients) under the conditions of each of the Examples and Comparative Examples to obtain an extraction liquid, and this extraction liquid was measured with Brix measuring apparatus (DD-7 manufactured by ATAGO CO., LTD), and the obtained numerical value was converted to a final mass up amount in each of the Examples and Comparative Examples, and listed in Table.

(Total Solid Content)

The total solid content was measured with Brix measurement method as described below.

(Acid Degree)

The black tea beverage packed in a container obtained in Examples and Comparative Examples (sample) and fruit juice was added with pure water, and then measurement was performed with potentiometric titration method with 0.1 mol/L sodium hydroxide solution until pH 8.3.

The acid degree (converted to citric acid) was calculated from the titer of the sodium hydroxide solution. Calculation was implemented with a measuring apparatus, and the indicated value of the device was recorded as the acid degree.

(Brix: Refraction Analysis)

The temperature of the measuring apparatus was adjusted to the given temperature, and the measuring apparatus (refractometer) was corrected, the black tea beverage packed in a container obtained in Examples and Comparative Examples (sample) was thinly applied onto the prism of the measuring apparatus, and Brix was measured (indicated value of the device was recorded).

(pH: Glass Electrode Method)

A pH meter was corrected with pH standard solution, and the black tea beverage packed in a container obtained in Examples and Comparative Examples (sample) was collected to a beaker, and the glass electrode of the pH meter was inserted into the sample, and the pH was measured (indicated value of the device was recorded).

(Degree of Sweetness/Dryness)

From the total solid content and the acid degree measured with the methods described above, the degree of sweetness/dryness was calculated with the following equation.

Degree of sweetness/dryness=0.86×total solid content (Bx)−1.16×acid degree−1.31

<Extraction Liquid of Black Tea A>

100 g of blend black tea leaves produced in Sri Lanka was added to 3000 g of ion exchanged water heated to 60° C., and extracted for 3 minutes with stirring. The obtained extraction liquid of black tea was filtered with a stainless-steel mesh (20 mesh), and further filtered with a stainless-steel mesh (80 mesh). The filtrate was cooled to 15° C., and then filtered with flannel, to obtain Extraction liquid of black tea A.

This Extraction liquid of black tea A contained 0.9 mass % of the soluble solid content, 0.04 mass % of caffeine, 0.008 mass % of theogallin, and 0.005 mass % of theaflavins. [0053]

<Extraction Liquid of Black Tea B>

100 g of Darjeeling black tea leaves was added to 3000 g ion exchanged water heated to 30° C., and extracted for 20 minutes with stirring. The obtained extraction liquid of black tea was filtered with a stainless-steel mesh (20 mesh), and further filtered with a stainless-steel mesh (80 mesh). The filtrate was cooled to 15° C., and then filtered with flannel, to obtain Extraction liquid of black tea B.

This Extraction liquid of black tea B contained 0.9 mass % of the soluble solid content, 0.048 mass % of caffeine, 0.015 mass % of theogallin, and 0.001 mass % of theaflavins.

<Black Tea Concentrate>

100 g of commercially available black tea leaves finished with supercritical treatment (manufactured by Plantextrakt) was added to 3000 g of ion exchanged water heated to 60° C., and extracted for 10 minutes with stirring. The obtained extraction liquid of black tea was filtered with a stainless-steel mesh (20 mesh), and further filtered with a stainless-steel mesh (80 mesh). The filtrate was cooled to 15° C., and then filtered with flannel, and further concentrated with a rotation thin type evaporator, to obtain a black tea concentrate.

This black tea concentrate contained 50.0 mass % of the soluble solid content, 0.14 mass % of caffeine, 0.44 mass % of theogallin, and 0.17 mass % of theaflavins.

### Example 1

500.0 g of Extraction liquid of black tea A and 21.0 g of the black tea concentrate were added with 40.0 g of apple fruit juice (straight), 1.1 g of tartaric acid, 1.0 g of citric acid, 183 g of granulated sugar, and 100 g of fructose, diluted, and then added with sodium bicarbonate so that the pH became 3.80, and further added with 10 g flavoring agent, and the total amount was diluted to be 10,000 g with pure water.

Such blended black tea beverage was heated to 95° C. of the temperature for sterilization, and then was filled into a PET bottle container and cooled, to obtain a black tea beverage packed in a container (sample).

### Examples 2-12 and Comparative Examples 1-10

The addition amounts of Extraction liquids of black tea A to B, the black tea concentrate and various additives were changed as listed in Table 1 and Table 2, and the black tea beverage packed in a container (sample) was manufactured on the basis of the method of preparing the sample of Example 1.

(Sensory Examination 1)

With respect to the beverages obtained in Examples 1-12 and Comparative Examples 1-10 (25° C. temperature), 10 trained examiners (panels) gave a score in 4-step evaluation of 1 to 4 on the following criteria for the 4 items of the acid taste, the sweet taste, the bitter astringent taste and the convergent taste, and rounded the scores to get the average point. With respect to the total evaluation, the average points of the evaluation items were evaluated such that “⊚ (double circle)” indicates 3.5 or more, “∘ (circle)” indicates 3 or more and less than 3.5, “Δ (triangle)” indicates 2 or more and less than 3, and “× (cross)” indicates 1 or more and less than 2.

=Acid Taste=

4: Particularly good

3: Good

2: Usual

1: Not enough

=Sweet Taste=

4: Particularly good

3: Good

2: Usual

1: Bad

=Bitter Astringent Taste=

4: Particularly small

3: Small

2: Sensed

1: Strongly sensed

=Convergent Taste=

4: Particularly small

3: Small

2: Sensed

1: Strongly sensed

TABLE 1

| | | | Example 1 | Example 2 | Example 3 | Example 4 | Example 5 | Example 6 | Example 7 |
|---|---|---|---|---|---|---|---|---|---|
| Blend | Extraction liquid of black tea A | mass % | 8.00 | 8.28 | 7.80 | 8.78 | 10.00 | 7.80 | 7.80 |
| | Extraction liquid of black tea B | mass % | | | | | | | |
| | Black tea concentrate | mass % | [symbol] | [symbol] | [symbol] | [symbol] | [symbol] | [symbol] | [symbol] |
| | Apple fruit juice | mass % | 0.40 | — | 0.40 | 0.40 | 0.40 | 0.40 | 0.40 |
| | Orangle fruit juice | mass % | — | 0.18 | — | — | — | — | — |
| | Tartaric acid | mass % | [symbol] | [symbol] | 0.028 | [symbol] | 0.044 | 0.028 | [symbol] |
| | Citric acid | mass % | [symbol] | [symbol] | [symbol] | [symbol] | 0.040 | [symbol] | [symbol] |
| | Granulated sugar | mass % | 1.88 | 1.88 | [symbol] | 1.75 | [symbol] | [symbol] | [symbol] |
| | Acesulfate-K | mass % | — | — | — | 0.007 | — | — | — |
| | Fructose | mass % | 1.00 | 1.00 | 1.00 | 1.00 | 1.24 | 1.00 | 1.00 |
| | Flavoring agent | mass % | 0.10 | 0.10 | 0.10 | [symbol] | [symbol] | [symbol] | [symbol] |
| | Sodium bicarbonate | mass % | Adjusted | Adjusted | Adjusted | Adjusted | Adjusted | Adjusted | Adjusted |
| | Pure water | mass % | Adjusted | Adjusted | Adjusted | Adjusted | Adjusted | Adjusted | Adjusted |
| | Total amount | mass % | 100 | 100 | 100 | 100 | 100 | 100 | 100 |
| Analyzed | pH | — | 3.80 | 3.80 | 3.80 | 3.80 | 3.80 | 3.80 | 3.80 |
| value | Solid content derived from a black tea | % | [symbol] | [symbol] | [symbol] | [symbol] | [symbol] | 0.830 | [symbol] |
| Calculated | Caffeine | mass % | 0.0028 | 0.0027 | 0.0082 | 0.0087 | [symbol] | 0.0084 | [symbol] |
| value | Catechins | mass % | [symbol] | 0.0084 | [symbol] | 0.0086 | 0.0087 | 0.0084 | 0.0084 |
| | Theogallin | mass % | [symbol] | [symbol] | [symbol] | [symbol] | [symbol] | 0.00257 | [symbol] |
| | Caffeine/Theogallin | — | 1.74 | 2.02 | 2.87 | [symbol] | 3.09 | 1.88 | 3.87 |
| | Theaflavins | mass % | 0.00081 | 0.00084 | [symbol] | [symbol] | [symbol] | [symbol] | [symbol] |
| | Theogallin/Theaflavins | — | 1.10 | 2.10 | 2.00 | 1.80 | [symbol] | 2.27 | 2.00 |
| | Acid degree | % | [symbol] | [symbol] | [symbol] | [symbol] | [symbol] | [symbol] | [symbol] |
| | Total solid content | % | 8.80 | 8.80 | 8.80 | 8.50 | 4.10 | [symbol] | [symbol] |
| | Degree of sweetness/dryness | — | 1.80 | 1.80 | 1.00 | 1.88 | [symbol] | [symbol] | [symbol] |
| Evaluation | Acid taste | — | 4 | 4 | 4 | 3 | 3 | 4 | 3 |
| | Sweet taste | — | 3 | 2 | 4 | 4 | 4 | 4 | 4 |
| | Bitter astringant taste | — | 3 | 3 | 4 | 3 | 3 | 3 | 4 |
| | Convergant taste | — | 2 | 2 | 4 | 3 | 3 | 4 | 4 |
| | Total | — | ◯ | ◯ | ⊚ | ◯ | ◯ | ⊚ | ⊚ |

| | | Example 8 | Example 9 | Example 10 | Example 11 | Example 12 |
|---|---|---|---|---|---|---|
| Blend | Extraction liquid of black tea A | — | 4.00 | 3.80 | 12.86 | 12.86 |
| | Extraction liquid of black tea B | 7.80 | 8.80 | | | |
| | Black tea concentrate | [symbol] | [symbol] | [symbol] | [symbol] | [symbol] |
| | Apple fruit juice | 0.40 | 0.40 | 0.40 | 0.40 | 0.40 |
| | Orangle fruit juice | — | — | — | — | — |
| | Tartaric acid | [symbol] | [symbol] | 0.028 | [symbol] | [symbol] |
| | Citric acid | [symbol] | [symbol] | [symbol] | [symbol] | [symbol] |
| | Granulated sugar | [symbol] | [symbol] | [symbol] | [symbol] | [symbol] |
| | Acesulfate-K | — | — | — | — | — |
| | Fructose | 1.00 | 1.00 | 1.00 | 1.00 | 1.00 |
| | Flavoring agent | [symbol] | [symbol] | [symbol] | [symbol] | [symbol] |
| | Sodium bicarbonate | Adjusted | Adjusted | Adjusted | Adjusted | Adjusted |
| | Pure water | Adjusted | Adjusted | Adjusted | Adjusted | Adjusted |
| | Total amount | 100 | 100 | 100 | 100 | 100 |
| Analyzed | pH | 3.80 | 3.80 | 3.80 | 3.80 | 3.80 |
| value | Solid content derived from a black tea | [symbol] | [symbol] | [symbol] | [symbol] | [symbol] |
| Calculated | Caffeine | 0.0085 | 0.0088 | [symbol] | 0.0080 | 0.0080 |
| value | Catechins | 0.0084 | 0.0084 | [symbol] | [symbol] | [symbol] |
| | Theogallin | [symbol] | [symbol] | [symbol] | [symbol] | 0.00104 |
| | Caffeine/Theogallin | [symbol] | [symbol] | [symbol] | 4.88 | 4.88 |
| | Theaflavins | [symbol] | [symbol] | [symbol] | [symbol] | [symbol] |
| | Theogallin/Theaflavins | 8.30 | [symbol] | 8.30 | 1.00 | 1.00 |
| | Acid degree | [symbol] | [symbol] | [symbol] | [symbol] | [symbol] |
| | Total solid content | 4.48 | 8.78 | 8.84 | 4.80 | 8.84 |
| | Degree of sweetness/dryness | 8.80 | 1.00 | [symbol] | 1.80 | [symbol] |
| Evaluation | Acid taste | 2 | 3 | 4 | 3 | 4 |
| | Sweet taste | 4 | 4 | 3 | 4 | 2 |
| | Bitter astringant taste | 3 | 4 | 4 | 3 | 4 |
| | Convergant taste | 4 | [symbol] | [symbol] | 3 | 2 |
| | Total | ◯ | ⊚ | ◯ | ◯ | ◯ |

[symbol]

indicates data missing or illegible when filed

TABLE 2

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Blend | Extraction liquid of black tea A | mass % | 8.00 | 8.28 | 8.78 | 10.00 | 7.80 | 16.80 |
| | Extraction liquid of black tea B | mass % | — | — | — | — | — | — |
| | Black tea concentrate | mass % | 0.21 | 0.19 | 0.14 | 0.12 | 0.17 | 0.001 |
| | Apple fruit juice | mass % | 0.40 | — | 0.40 | 0.40 | 0.40 | 0.40 |
| | Orange fruit juice | mass % | — | 0.18 | — | — | — | — |
| | Tartaric acid | mass % | 0.023 | [symbol] | 0.023 | [symbol] | [symbol] | 0.023 |
| | Citric acid | mass % | 0.028 | [symbol] | 0.028 | [symbol] | [symbol] | 0.028 |
| | Granulated sugar | mass % | 2.38 | 3.20 | 2.88 | 2.98 | 2.88 | 2.10 |
| | Fructose | mass % | 2.00 | 2.00 | 2.00 | 2.00 | 2.00 | 1.00 |
| | Flavoring agent | mass % | [symbol] | [symbol] | [symbol] | [symbol] | [symbol] | [symbol] |
| | Sodium bicarbonate | mass % | Adjusted | Adjusted | Adjusted | Adjusted | Adjusted | Adjusted |
| | Pure water | mass % | Adjusted | Adjusted | Adjusted | Adjusted | Adjusted | Adjusted |
| | Total amount | mass % | 100 | 100 | 100 | 100 | 100 | 100 |
| Analyzed | pH | — | 3.80 | 3.80 | 3.80 | 3.80 | 3.80 | 3.80 |
| value | Solid content derived from a black tea | % | [symbol] | [symbol] | [symbol] | [symbol] | [symbol] | [symbol] |
| Calculated | Caffeine | mass % | 0.0028 | 0.0028 | 0.0087 | [symbol] | 0.0082 | 0.0087 |
| value | Catechins | mass % | 0.0088 | 0.0084 | 0.0085 | 0.0087 | 0.0084 | 0.0089 |
| | Theogallin | mass % | [symbol] | [symbol] | [symbol] | [symbol] | [symbol] | [symbol] |
| | Caffeine/Theogallin | — | [symbol] | [symbol] | [symbol] | 2.03 | 2.37 | 4.99 |
| | Theaflavins | mass % | [symbol] | 0.00054 | [symbol] | 0.00070 | 0.00088 | [symbol] |
| | Theogallin/Theaflavins | — | 2.16 | 2.10 | 1.98 | 1.89 | 2.03 | 1.80 |
| | Acid degree | % | 0.08 | 0.02 | [symbol] | 0.02 | 0.03 | 0.08 |
| | Total solid content | % | 8.03 | 8.62 | 8.08 | 8.62 | 8.62 | 8.80 |
| | Degree of sweetness/dryness | — | 1.00 | 3.00 | 1.00 | 3.00 | 3.00 | [symbol] |
| Evaluation | Acid taste | — | 3 | 2 | 3 | 2 | 2 | 2 |
| | Sweet taste | — | 2 | 4 | 2 | 1 | 1 | 3 |
| | Bitter astringant taste | — | 3 | 2 | 2 | 2 | 2 | 1 |
| | Convergant taste | — | 2 | 3 | 3 | 2 | 2 | 1 |
| | Total | — | Δ | Δ | Δ | X | X | X |

| | | | Comparative | Comparative | Comparative | Comparative |
|---|---|---|---|---|---|---|
| | | | Example 7 | Example 8 | Example 9 | Example 10 |
| Blend | Extraction liquid of black tea A | mass % | 1.28 | 18.80 | — | 7.80 |
| | Extraction liquid of black tea B | mass % | — | — | 7.80 | — |
| | Black tea concentrate | mass % | 0.26 | 0.001 | 0.17 | 0.17 |
| | Apple fruit juice | mass % | 0.40 | 0.40 | 0.40 | 0.40 |
| | Orange fruit juice | mass % | — | — | — | — |
| | Tartaric acid | mass % | 0.023 | 0.023 | 0.0005 | 0.070 |
| | Citric acid | mass % | 0.028 | 0.028 | 0.0005 | 0.080 |
| | Granulated sugar | mass % | 2.08 | 4.30 | 2.10 | 2.10 |
| | Fructose | mass % | 0.00 | 1.00 | 1.00 | 1.00 |
| | Flavoring agent | mass % | [symbol] | [symbol] | [symbol] | [symbol] |
| | Sodium bicarbonate | mass % | Adjusted | Adjusted | Adjusted | Adjusted |
| | Pure water | mass % | Adjusted | Adjusted | Adjusted | Adjusted |
| | Total amount | mass % | 100 | 100 | 100 | 100 |
| Analyzed | pH | — | 8.80 | 8.80 | 8.80 | 8.80 |
| value | Solid content derived from a black tea | % | [symbol] | [symbol] | [symbol] | [symbol] |
| Calculated | Caffeine | mass % | 0.0003 | 0.0087 | 0.0082 | 0.0082 |
| value | Catechins | mass % | 0.0080 | 0.0089 | 0.0085 | 0.0084 |
| | Theogallin | mass % | [symbol] | [symbol] | [symbol] | [symbol] |
| | Caffeine/Theogallin | — | 0.88 | 4.99 | 1.71 | 2.87 |
| | Theaflavins | mass % | 0.00084 | 0.00084 | [symbol] | 0.00088 |
| | Theogallin/Theaflavins | — | 2.47 | 1.80 | 8.20 | 2.03 |
| | Acid degree | % | 0.08 | 0.08 | [symbol] | [symbol] |
| | Total solid content | % | 2.78 | 6.00 | [symbol] | [symbol] |
| | Degree of sweetness/dryness | — | 1.00 | 3.79 | 1.98 | 1.82 |
| Evaluation | Acid taste | — | 2 | 3 | 1 | 1 |
| | Sweet taste | — | 1 | 1 | 3 | 3 |
| | Bitter astringant taste | — | 2 | 1 | 3 | 3 |
| | Convergant taste | — | 1 | 1 | 1 | 1 |
| | Total | — | X | X | Δ | Δ |

[symbol]

indicates data missing or illegible when filed

(Discussion)

From the results of Tables 1 and 2, it was found out that when the content of caffeine, the acid degree, and the degree of sweetness/dryness are within certain ranges, it allows a black tea beverage to present good acid taste and sweet taste as much, and to have small bitter astringent taste and convergent taste, and to have small pungent taste at the time of drinking.

From such point, it can be considered that in a black tea beverage that contains caffeine in 0.001 to 0.005 mass %, and contains a sweetener and fruit juice, adjustment of the acid degree to a range of 0.02 to 0.08%, and adjustment of the degree of sweetness/dryness represented by the sugar degree (total solid content) and the acid degree to a range of 1.50 to 2.50 when the acid degree is within the range, allow the black tea beverage to have the bitter astringent taste and the convergent taste suppressed and to be sensed soft with the low pungent taste.

Furthermore, from the results of Tables 1 and 2, it was also found out that when the ratio of the content of caffeine with respect to the content of theogallin is within a certain range, it allows a black tea beverage to have further better balance of the bitter astringent taste and the astringent taste, and to have small pungent taste thereby.

From such point, it can be considered that the ratio of the content of caffeine with respect to the content of theogallin is preferably 1.0 to 4.9, particularly 1.5 or more and 4.5 or less and further particularly preferably 2.0 or more and 4.0 or less from a viewpoint of a balance of the bitter astringent taste and the astringent taste.

### Examples 13-17

The addition amounts of Extraction liquid of black tea

A, the black tea concentrate, and various additives were changed as listed in Table 3, and the black tea beverage packed in a container (sample) was, manufactured on the basis of the method of preparing the sample of Example 1.

(Sensory Examination 2)

With respect to the beverages obtained in Examples 13-17 (25° C. temperature), 10 trained examiners (panelists) gave a score in 4-step evaluation of 1 to 4 for the 2 items of the aftertaste and the refreshing taste on the following criteria, and rounded the scores to get the average point. With respect to the total evaluation, the average points of the evaluation items were evaluated such that “⊚ (double circle)” indicates 3.5 or more, “∘ (circle)” indicates 3 or more and less than 3.5, “Δ (triangle)” indicates 2 or more and less than 3, and “× (cross)” indicates 1 or more and less than 2.

=Aftertaste=

There was no residual astringent taste, and the refreshing aftertaste was evaluated on the following criteria.

4: Particularly good

3: Good

2: Usual

1: Bad

=Refreshing Taste=

Refreshing and soft acid taste was evaluated on the following criteria.

4: Particularly good

3: Good

2: Usual

1: Bad

TABLE 3

| | | | Example 13 | Example 14 | Example 15 | Example 16 | Example 17 |
|---|---|---|---|---|---|---|---|
| Blend | Extraction | mass % | 7.50 | 7.50 | 7.50 | 7.50 | 7.50 |
| | liquid of black | | | | | | |
| | tea A | | | | | | |
| | Black tea | mass % | 0.170 | 0.170 | 0.170 | 0.170 | 0.170 |
| | concentrate | | | | | | |
| | Apple fruit | mass % | 0.400 | 0.400 | 0.400 | 0.400 | 0.400 |
| | juice | | | | | | |
| | Tartaric acid | mass % | 0.006 | 0.02 | 0.029 | 0.040 | 0.050 |
| | Citric acid | mass % | 0.045 | 0.038 | 0.025 | 0.016 | 0.007 |
| | Granulated sugar | mass % | 2.10 | 2.10 | 2.10 | 2.10 | 2.10 |
| | Fructose | mass % | 1.00 | 1.00 | 1.00 | 1.00 | 1.00 |
| | Flavoring agent | mass % | 0.10 | 0.10 | 0.10 | 0.10 | 0.10 |
| | Sodium | mass % | Adjusted | Adjusted | Adjusted | Adjusted | Adjusted |
| | bicarbonate | | | | | | |
| | Pure water | mass % | Adjusted | Adjusted | Adjusted | Adjusted | Adjusted |
| | Total amount | mass % | 100 | 100 | 100 | 100 | 100 |
| Analyzed | pH | — | 3.80 | 3.80 | 3.80 | 3.80 | 3.80 |
| value | Solid content | % | 0.150 | 0.150 | 0.150 | 0.150 | 0.150 |
| Calculated | derived from a | | | | | | |
| value | black tea | | | | | | |
| | Caffeine | mass % | 0.0032 | 0.0032 | 0.0032 | 0.0032 | 0.0032 |
| | Catechins | mass % | 0.0034 | 0.0034 | 0.0034 | 0.0034 | 0.0034 |
| | Theogallin | mass % | 0.00135 | 0.00135 | 0.00135 | 0.00135 | 0.00135 |
| | Caffeine/ | — | 2.37 | 2.37 | 2.37 | 2.37 | 2.37 |
| | Theogallin | | | | | | |
| | Theaflavins | mass % | 0.00066 | 0.00066 | 0.00066 | 0.00066 | 0.00066 |
| | Theogallin/ | — | 2.03 | 2.03 | 2.03 | 2.03 | 2.03 |
| | Theaflavins | | | | | | |
| | Acid degree | % | 0.05 | 0.05 | 0.05 | 0.05 | 0.05 |
| | Total solid | % | 3.80 | 3.80 | 3.80 | 3.80 | 3.80 |
| | content | | | | | | |
| | Degree of | — | 1.90 | 1.90 | 1.90 | 1.90 | 1.90 |
| | sweetness/dryness | | | | | | |
| | Content of | — | 0.12 | 0.34 | 0.54 | 0.71 | 0.87 |
| | tartaric | | | | | | |
| | acid/content of | | | | | | |
| | acidic | | | | | | |
| | ingredients | | | | | | |
| Evaluation | Aftertaste | — | 3 | 4 | 4 | 3 | 3 |
| | Refreshing taste | — | 3 | 3 | 4 | 4 | 3 |
| | Total | — | ◯ | ⊚ | ⊚ | ⊚ | ◯ |

(Discussion)

From the results of Table 3, it was found out that when the ratio of the content of tartaric acid with respect to the content of acidic ingredients (tartaric acid/acidic ingredients) is within a certain range, it allows a black tea beverage to have refreshing and soft acid taste, and to have refreshing aftertaste without residual astringent taste.

From such point, it can be considered that the ratio of the content of tartaric acid with respect to the content of acidic ingredients (tartaric acid/acidic ingredients) is preferably 0.30 to 0.80, particularly 0.4 or more and 0.7 or less, and further more preferably 0.45 or more and 0.65 or less from a viewpoint of the aftertaste and refreshing taste.

### Examples 18-23

The addition amounts of Extraction liquid of black tea A, the black tea concentrate, and various additives were changed as listed in Table 4, and the black tea beverage packed in a container (sample) was manufactured on the basis of the method of preparing the sample of Example 1.

(Sensory Examination 3)

With respect to the beverages obtained in Examples 18-23 (25° C. temperature), 10 trained examiners (panelists) gave a score in 4-step evaluation of 1 to 4 for the 2 items of the odor and the richness taste on the following criteria, and rounded the scores to get the average point. With respect to the total evaluation, the average points of the evaluation items were evaluated such that “⊚ (double circle)” indicates 3.5 or more, “∘ (circle)” indicates 3 or more and less than 3.5, “Δ (triangle)” indicates 2 or more and less than 3, and “× (cross)” indicates 1 or more and less than 2.

=Odor=

The odor note through the nose was evaluated on the following criteria.

4: Particularly good

3: Good

2: Usual

1: Bad

=Richness Taste=

The concentration feeling and the flavor of the black tea were evaluated on the following criteria.

4: Particularly good

3: Good

2: Usual

1: Bad

TABLE 4

| | | | Example 18 | Example 19 | Example 20 | Example 21 | Example 22 | Example 23 |
|---|---|---|---|---|---|---|---|---|
| Blend | Extraction | mass % | 4.20 | 6.66 | 6.66 | 6.66 | 6.66 | 6.66 |
| | liquid of black | | | | | | | |
| | tea A | | | | | | | |
| | Black tea | mass % | 0 | 0.03 | 0.18 | 0.26 | 0.48 | 0.64 |
| | concentrate | | | | | | | |
| | Apple fruit | mass % | 0.400 | 0.400 | 0.400 | 0.400 | 0.400 | 0.400 |
| | juice | | | | | | | |
| | Tartaric acid | mass % | 0.029 | 0.012 | 0.012 | 0.029 | 0.040 | 0.050 |
| | Citric acid | mass % | 0.025 | 0.038 | 0.038 | 0.025 | 0.016 | 0.007 |
| | Granulated sugar | mass % | 2.10 | 2.17 | 2.17 | 2.06 | 1.95 | 1.87 |
| | Fructose | mass % | 1.00 | 1.00 | 1.00 | 1.00 | 1.00 | 1.00 |
| | Flavoring agent | mass % | 0.10 | 0.10 | 0.10 | 0.10 | 0.10 | 0.10 |
| | Sodium | mass % | Adjusted | Adjusted | Adjusted | Adjusted | Adjusted | Adjusted |
| | bicarbonate | | | | | | | |
| | Pure water | mass % | Adjusted | Adjusted | Adjusted | Adjusted | Adjusted | Adjusted |
| | Total amount | mass % | 100 | 100 | 100 | 100 | 100 | 100 |
| Analyzed | pH | — | 3.80 | 3.80 | 3.80 | 3.80 | 3.80 | 3.80 |
| value | Solid content | % | 0.038 | 0.076 | 0.150 | 0.190 | 0.300 | 0.380 |
| Calculated | derived from a | | | | | | | |
| value | black tea | | | | | | | |
| | Caffeine | mass % | 0.0016 | 0.0026 | 0.0029 | 0.0030 | 0.0033 | 0.0035 |
| | Theogallin | mass % | 0.00034 | 0.00053 | 0.00133 | 0.00168 | 0.00265 | 0.00335 |
| | Caffeine/ | — | 4.76 | 4.96 | 2.15 | 1.77 | 1.24 | 1.04 |
| | Theogallin | | | | | | | |
| | Theaflavins | mass % | 0.00021 | 0.00038 | 0.00064 | 0.00077 | 0.00115 | 0.00142 |
| | Theogallin/ | — | 1.60 | 1.40 | 2.08 | 2.17 | 2.31 | 2.36 |
| | Theaflavins | | | | | | | |
| | Acid degree | % | 0.05 | 0.05 | 0.05 | 0.05 | 0.05 | 0.05 |
| | Total solid | % | 3.80 | 3.80 | 3.80 | 3.80 | 3.80 | 3.80 |
| | content | | | | | | | |
| | Degree of | — | 1.90 | 1.90 | 1.90 | 1.90 | 1.90 | 1.90 |
| | sweetness/dryness | | | | | | | |
| | Solid content | % | 1.0 | 2.0 | 3.9 | 5.0 | 7.9 | 10.0 |
| | derived from the | | | | | | | |
| | black tea/Total | | | | | | | |
| | solid content × 100 | | | | | | | |
| Evaluation | Odor | — | 3 | 4 | 4 | 4 | 3 | 3 |
| | Richness taste | — | 3 | 3 | 4 | 4 | 4 | 3 |
| | Total | — | ◯ | ⊚ | ⊚ | ⊚ | ⊚ | ◯ |

(Discussion)

From the results of Table 4, it was found out that when ratio of the solid content derived from the black tea with respect to the total solid content is within a certain range, it allows a black tea beverage to have excellent odor note through the nose, and appropriate concentration feeling (the richness taste) of the black tea.

From such point, it can be considered that the ratio of the solid content derived from a black tea with respect to the total solid content is preferably 2.0 to 8.0%, particularly 3.0% or more and 7.0% or less and further particularly preferably 4.0% or more and 5.0% or less from a viewpoint of the odor and the richness taste.

### Examples 24-26

The addition amounts of extraction liquid of black tea A, the black tea concentrate, and various additives were changed as listed in Table 5, and the black tea beverage packed in a container (sample) was manufactured on the basis of the method of preparing the sample of Example 1.

(Sensory Examination 4)

With respect to the beverage obtained in Examples 24-26 (25° C. temperature), 10 trained examiners (panelists) gave a score in 4-step evaluation of 1 to 4 for the 2 items of the aftertaste and the texture of the fruit juice on the following criteria, and rounded the scores to get the average point. With respect to the total evaluation, the average points of the evaluation items were evaluated such that “⊚ (double circle)” indicates 3.5 or more, “∘ (circle)” indicates 3 or more and less than 3.5, “Δ (triangle)” indicates 2 or more and less than 3, and “× (cross)” indicates 1 or more and less than 2.

=Aftertaste=

The refreshing feeling of drink going down one's throat, and the refreshing aftertaste were evaluated on the following criteria.

4: Particularly good

3: Good

2: Usual

1: Bad

=Texture of the Fruit Juice=

The concentration feeling and the flavor of the fruit juice were evaluated on the following criteria.

4: Particularly good

3: Good

2: Usual

1: Bad

TABLE 5

| | | | Example 24 | Example 25 | Example 26 |
|---|---|---|---|---|---|
| Blend | Extraction liquid of | mass % | 6.66 | 6.66 | 6.66 |
| | black tea A | | | | |
| | Black tea concentrate | mass % | 0.18 | 0.18 | 0.18 |
| | Apple fruit juice *1 | mass % | 0.40 | — | — |
| | Orange fruit juice *2 | mass % | — | 0.15 | — |
| | Lemon fruit juice *3 | mass % | — | — | 0.02 |
| | Bergamot fruit juice *4 | mass % | — | 0.015 | — |
| | Tartaric acid | mass % | 0.029 | 0.029 | 0.029 |
| | Citric acid | mass % | 0.025 | 0.025 | 0.025 |
| | Granulated sugar | mass % | 2.06 | 2.06 | 2.06 |
| | Fructose | mass % | 1.00 | 1.00 | 1.00 |
| | Flavoring agent | mass % | 0.10 | 0.10 | 0.10 |
| | Sodium bicarbonate | mass % | Adjusted | Adjusted | Adjusted |
| | Pure water | mass % | Adjusted | Adjusted | Adjusted |
| | Total amount | mass % | 100 | 100 | 100 |
| Analyzed | pH | — | 3.80 | 3.80 | 3.80 |
| value | Solid content derived | % | 0.150 | 0.150 | 0.150 |
| Calculated | from a black tea | | | | |
| value | Caffeine | mass % | 0.0029 | 0.0029 | 0.0029 |
| | Theogallin | mass % | 0.00133 | 0.00133 | 0.00133 |
| | Caffeine/Theogallin | — | 2.18 | 2.18 | 2.18 |
| | Theaflavins | mass % | 0.00064 | 0.00064 | 0.00064 |
| | Theogallin/Theaflavins | — | 2.08 | 2.08 | 2.08 |
| | Acid degree | % | 0.05 | 0.05 | 0.05 |
| | Total solid content | % | 3.80 | 3.80 | 3.80 |
| | Degree of | — | 1.90 | 1.90 | 1.90 |
| | sweetness/dryness | | | | |
| Evaluation | Aftertaste | — | 4 | 4 | 3 |
| | Texture of fruit juice | — | 3 | 4 | 3 |
| | Total | — | ⊚ | ⊚ | ◯ |

*1 Acid degree 0.24%,
*2 Acid degree 0.65%,
*3 Acid degree 4.40%,
*4 Acid degree 2.33%

(Discussion)

From the results of Table 5, it was found out that when the acid degree of the fruit juice added is within a certain range, it allows a black tea beverage to be more excellent in the aftertaste, the concentration feeling and the flavor of the fruit juice at the time of drinking.

From such point, it can be considered that the acid degree of the fruit juice added is preferably 3.0% or less, particularly 0.1% or more and 2.0% or less and further particularly 0.2% or more and 1.0% or less from a viewpoint of enhancing the aftertaste and the texture of the fruit juice of the black tea beverage.

1. A black tea beverage packed in a container comprising caffeine in 0.001 to 0.005 mass %, a sweetener and fruit juice, wherein;
an acid degree is in a range of 0.02 to 0.08%; and,
a degree of sweetness/dryness represented by a sugar degree (total solid content) and an acid degree is within a range of 1.50 to 2.50 when the acid degree is within the range.

2. The black tea beverage packed in a container according to claim 1, wherein a ratio of a content of tartaric acid with respect to a content of acidic ingredients is 0.30 to 0.80.

3. The black tea beverage packed in a container according to claim 1, wherein a ratio of a solid content derived from a black tea with respect to the sugar degree (total solid content) is 2.0 to 8.0%.

4. The black tea beverage packed in a container according to claim 1, wherein an acid degree of a fruit juice to be added (converted to straight) is 3.0% or less.

5. A method of manufacturing a black tea beverage packed in a container having caffeine in 0.001 to 0.005 mass %, a sweetener and fruit juice, comprising;
adjusting an acid degree to a range of 0.02 to 0.08%; and,
adjusting a degree of sweetness/dryness represented by a sugar degree (total solid content) and a acid degree to a range of 1.50 to 2.50 when the acid degree is within the range.

6. A method of adjusting a flavor of a black tea beverage packed in a container, comprising;
adjusting caffeine to 0.001 to 0.005 mass %;
adjusting an acid degree to a range of 0.02 to 0.08%; and,
adjusting a degree of sweetness/dryness represented by a sugar degree (total solid content) and a acid degree to a range of 1.50 to 2.50 when the acid degree is within the range.
